(19) United States
(12) Patent Application Publication
(10) Pub. No.: US 2016/0258717 A1
(43) Pub. Date: Sep. 8, 2016

(54) SYSTEM AND METHOD FOR AIMING WEAPONRY

(71) Applicant: Black Diamond Advanced Technology, Chandler, AZ (US)

(72) Inventors: Richard Antoni Stone, Phoenix, AZ (US); Brian Joseph Parma, Chandler, AZ (US); Zachary Paul Kruger, Chandler, AZ (US)

(21) Appl. No.: 14/618,019

(22) Filed: Feb. 10, 2015

Related U.S. Application Data
(60) Provisional application No. 61/943,223, filed on Feb. 21, 2014.

(51) Int. Cl. F41H 13/00; G06F 3/0481; G06F 3/0484

(52) U.S. Cl. CPC F41H 13/00; G06F 3/04842; G06F 3/04817

(57) ABSTRACT

A system and method are disclosed for streamlined battlefield direction of remote fire support. An exemplary method includes the steps of designating a target, designating a friendly soldier location, transmitting information about the target and the soldier location to a battlefield computer, determining by the battlefield computer available forms of fire support, formatting the target and soldier information in formats compatible with available forms of fire support, selecting at least one of the forms of fire support and transmitting the formatted target and soldier information to the selected form or fire support to call in a strike on the target.

### CROSS REFERENCE TO RELATED APPLICATIONS

This application claims priority under 35 USC 119(e) to provisional application 61/943,223 titled System and Method for Aiming Weaponry filed on Feb. 21, 2014. The entire provisional application is incorporated by reference herein.

### FIELD OF THE INVENTION

The invention relates generally to the field of control of weapons platforms and more specifically to the control of multiple weaponry assets from a single battlefield location.

### BACKGROUND

In the field of battlefield support there are existing systems and methods directed to close air support (CAS) of ground personnel. Individuals designated, for example, joint terminal attack controllers (JTACs), are equipped to call in air support from whatever assets may be in the area to use their weaponry against hostile forces. One means of communicating target information is the 9-line data set, which is standard in the United States armed forces for CAS. The elements of the 9-line are (1) I.P. -Initial Point (2) Heading (3) Distance (4) Target Elevation (5) Target Description (6) Target Location (7) Mark Type (for example a Laser marker) (8) Friendlies and (9) Egress. One means of transmitting the 9-line data set is via a battlefield computer with a radio link to the air support. While this information is necessary to pinpoint the target and to ensure the safety of the JTAC and other friendly troops and positions, it can be cumbersome and slow for a soldier under duress to transmit.

In addition to close air support there are other possible weapons platforms that may be able to assist the JTAC. These include, for example, air strikes, naval surface fire, electronic attack, artillery and other forms of surface to surface or air to surface fire support. In addition to the problem of the amount of time required to ascertain and provide the 9-line data, the battlefield soldier must contend with sorting through and providing a host of different data formats for various forms of fires support, often while in time-sensitive combat situations.

Thus a need exists for a more unified approach to streamlining the workload of a solder when calling in fires support on the battlefield.

### BRIEF DESCRIPTION OF THE DRAWINGS

FIG. 1 is an exemplary flow diagram of a method for designating and transmitting target data;

FIG. 2 is an exemplary battlefield target engagement system; and

FIG. 3 is an exemplary display screen of a battlefield computer.

### DETAILED SPECIFICATION

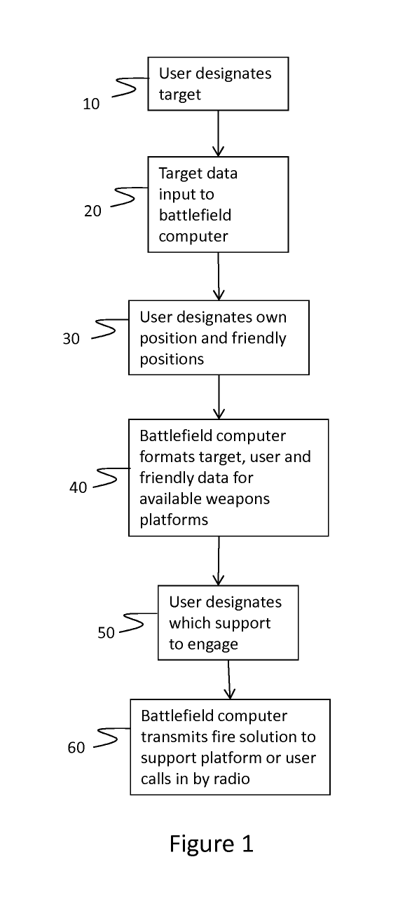

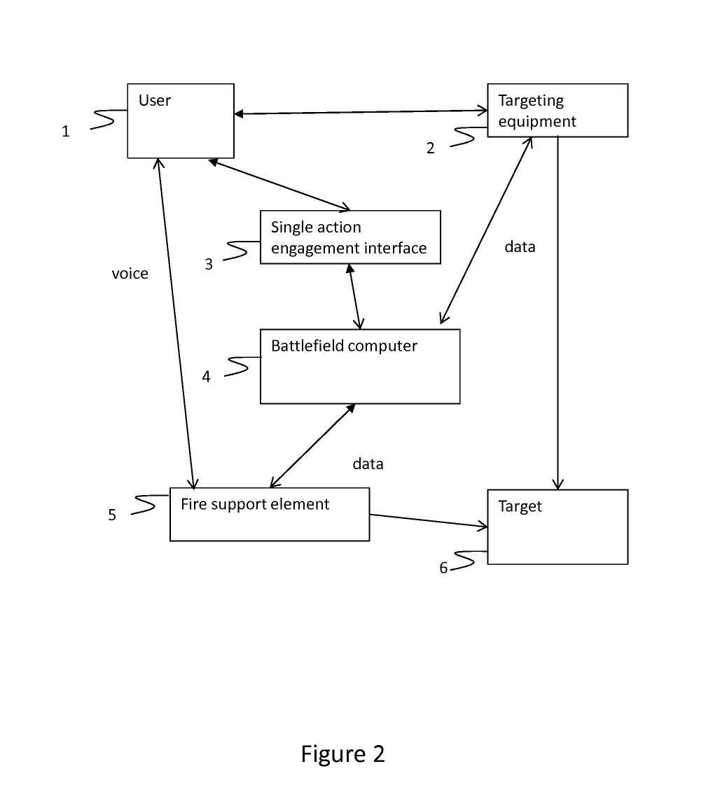

In an exemplary embodiment of the invention, a method is performed as illustrated in FIGS. 1 and 2, whereby the user 1 designates 10 a target 6, possibly with targeting equipment 2. The target information is input 20 either manually or automatically, through a wireless, optical or wired connection to a battlefield computer 4. The computer generates target information including location and elevation and gives the target an identification reference. The user also designates his or her position 30 and the position of friendly forces. The battlefield computer 4 determines what forms of fire support 5 are available and formats 40 the target information for each form of support. The user 1 then designates 50 which forms of support to call in and the computer sends 60 the appropriately-formatted data to the selected weapons platform. In an alternative embodiment, the computer displays the required engagement information and the user calls this in manually via radio.

Various tools may be used to designate the target and friendly positions locations, including a laser range finder, GPS data, on-screen maps and satellite photos. Some of these options may be connected to the battlefield computer such that the soldier need not manually enter position data but rather the data is automatically entered on a screen once a location is designated showing, for example, both text and a visual representation of the required information.

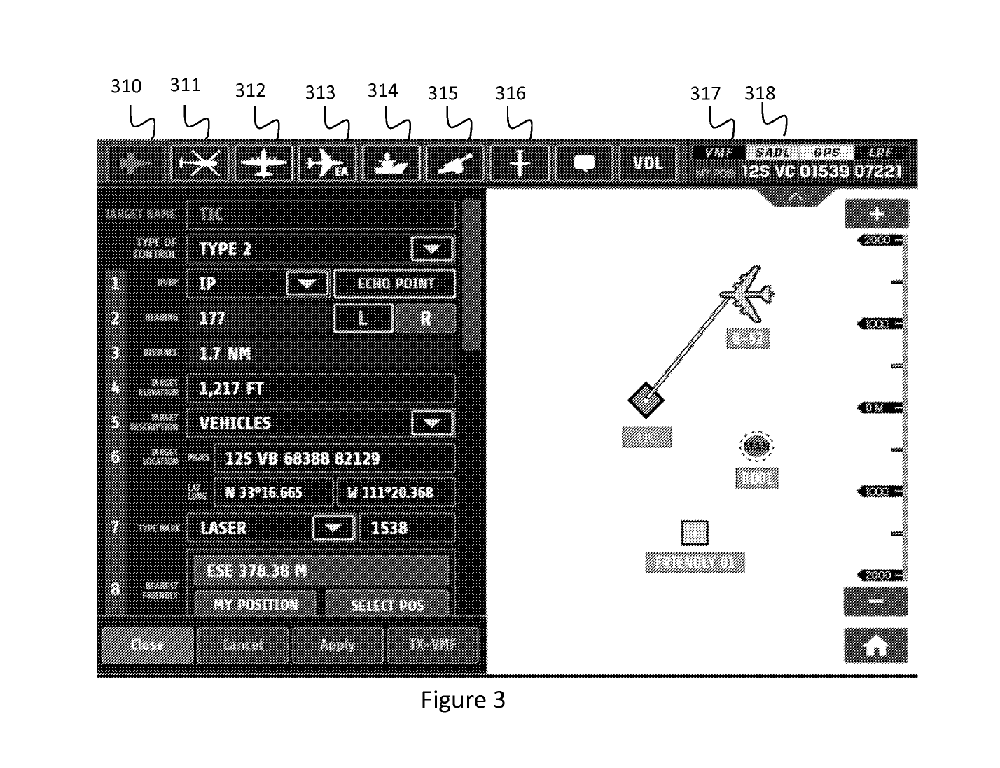

FIG. 3 is a screen shot of an exemplary engagement interface. The figure shows the first eight parts of a 9-line information on the left side: 1) I.P , 2) Heading, 3) Distance, 4) Target Elevation, 5) Target Description, 6) Target Location, 7) Mark Type [Laser] and 8) Friendly location and an annotated map on the right side. Possible forms of fire support are shown at the top for fighter plane 310, rotary wing 311, heavy bomber 313, electronic attack or jamming, 314, naval-based fire 314, ground artillery, 315 and pilotless weaponry 316. Those forms of support that are available can be shown in a different color than rest or only those that are available can be shown with different colors designating time to target or other relevant information.

Button 317, designates an input to initiate a VMF: Variable Message Format is a data link type (K-Series Message). This allows the user to digitally send messages and points to the aircraft. For example a user can send a K02.33 9-Line Message to the aircraft.

Button 318, designates and input to initiate an SADL, Situation Awareness Datalink, which is a data link type (J-Series Message). This allows the user to digitally send messages and points to the aircraft. For example a user can send a J28.2 Text Message to the aircraft.

The map side shows Troops in Contact (TIC), a B-52 airplane in range to bomb the TIC, the soldier's position (BD01) and a friendly location (Friendly 01). Typically, a terrain or satellite map would be shown with the symbols and characters shown on the right hand view of FIG. 3 overlaying the map. The map is not shown here for clarity. Another feature of the exemplary system and method is shown in FIG. 3, in that there is a line between the B52 and the TIC. This line is created when the fire support receives the data from the computer and sends back its target designation, confirming that it received the designated target. This gives the ground troops a visual confirmation of where the support fire will be aiming and provides a failsafe against misdirecting fire to a friendly location.

In a further embodiment, the battlefield computer provides a video display of the location of interest from a remotely-mounted camera. In a further embodiment, the remotely mounted camera is mounted on the fire support asset being called in to strike the target. In a further embodiment the battlefield computer displays a reticle on a map and the reticle is accompanied by graphical forms of available fire support. The reticle can be engaged to designate troops in contact. In a further embodiment, the battlefield computer displays a radio interface. In a further embodiment, the battlefield computer displays a text message interface.

1. A method for controlling fire support for ground troops comprising the following steps:
designating a target,
designating a soldier location,
transmitting information about said target and said soldier location to a battlefield computer,
determining by said battlefield computer available forms of fire support formatting said target and soldier location information in formats compatible with said available forms of fire support,
selecting at least one of said forms of fire support and
transmitting said formatted target and soldier location information to said selected form of fire support.

2. The method of claim 1, wherein said formatted target and soldier information are transmitted either verbally or digitally.

3. The method of claim 1, wherein said designating of a target is performed with designation equipment.

4. The method of claim 3, wherein said designation equipment is a laser rangefinder.

5. The method of claim 1, further comprising receiving by said battlefield computer target information from at least one of said forms of fire support.

6. The method of claim 5, further comprising displaying on a graphical user interface a map showing said target, said form of fire support and a link between said target and said form of fire support.

7. The method of claim 1, wherein at least one of said formats is a nine line format compatible with close air support.

8. A system for ground based troop command of remote weapons platforms comprising:
a battlefield computer having a user interface and display,
targeting equipment, and
at least one fire support element,
wherein, said battlefield computer is configured to
accept a target designation through said user interface,
accept a soldier location through said user interface,
receive information regarding available forms of fire support including said at least one fire support element,
display available forms of fire support,
format said target designation and soldier location in formats compatible with said available forms of fire support,
and
transmit said formatted target and soldier location information to said at least one fire support element.

9. The system of claim 8, wherein said battlefield computer is further configured to display a map, said map showing said target, said soldier location and location of at least one form of fire support.

10. The system of claim 8 wherein said battlefield computer is configured to display a target designation reticle, said reticle including available forms of fire support associated with said target.

11. The system of claim 8, wherein said targeting equipment includes at least one of the group consisting of: a laser range finder, a GPS and a map.

12. The system of claim 8, wherein said battlefield computer is configured to display an indicator connecting said at least one form of fire support and said target.
